(19) United States
(12) Patent Application Publication
(10) Pub. No.: US 2026/0094194 A1
(43) Pub. Date: Apr. 2, 2026

(54) SYSTEMS AND METHODS OF OBJECTIVE-BASED RECOMMENDATIONS USING A CUSTOM DATA MODEL

(71) Applicant: Salesforce, Inc., San Francisco, CA (US)

(72) Inventors: Christian BAYER, Cambridge, MA (US); Ian FROSST, Ontario (CA); David KEELEY-DEBONIS, Burlington, MA (US); Nihar GADKARI, Needham, MA (US)

(21) Appl. No.: 18/901,212

(22) Filed: Sep. 30, 2024

(51) Int. Cl. G06Q 30/0601; G06Q 30/0201

(52) U.S. Cl. CPC G06Q 30/0631; G06Q 30/0201

(57) ABSTRACT

Systems and methods are provided for generating, at a server, a customer-defined data model based on a received request and storing the defined data model in a data warehouse. The server may receive a recommendation objective based on the customer-defined data model. The server may extract customer-defined data from the data warehouse, and train a deep learning (DL) model using the customer-defined data toward the recommendation objective. The server may generate one or more recommendations for the user based on the customer-defined data and the recommendation objective for the user. The server may transmit the generated one or more recommendations to a device of the user for display.

### BACKGROUND

Current recommendation systems can provide personalization of content, but such systems typically use strategy-based recommendations. In such systems, custom rules and conditions control the recommendation process for an end user, which are provided by sorting or filtering operations.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIGS. 1-4C show example methods of generating personalized recommendations based on an objective and a trained user data model according to implementations of the disclosed subject matter.

FIGS. 5A-5B show an example system to generate objective-based recommendations with a trained user data model according to implementations of the disclosed subject matter.

FIG. 6 shows an example computer system to perform the example methods of FIGS. 1-4C and that may be configured to as the system shown in FIGS. 5A-5B according to implementations of the disclosed subject matter.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

Systems and methods of providing recommendations in implementations of the disclosed subject matter may be a shared real-time recommendations service that may use deep learning (DL), artificial intelligence (AI), and/or machine learning (ML). The system may generate tailored user content (i.e., recommendations) based on previous user behavior (e.g., interaction with one or more websites, applications, emails, or the like). The system may use DL, AI, and/or ML to train a recommendation model for the user based on an objective. That is, implementations of the disclosed subject matter may provide objective-based personalized recommendations for the user using a trained user data model.

Current recommendation systems typically use strategy-based personalization recommendations, which may provide an administrator control over the recommendation process for an end user. The administrator defines a set of rules and conditions, which are carried out by sorting and/or filtering operations. The present inventive concept differs from current systems in that it maps user data into a data model, and provides recommendations using the data model based on a generated recommendation objective. The data model includes different types of interactions and user behavior (e.g., different types of domain-specific data for a user are used to generate the data model). The data model of the disclosed subject matter may be freely defined by a customer (e.g., a customer, business, organization, and/or entity that may have tenant data stored in a data warehouse, data lake, or the like). The data model may be based on data that is already available to the customer, and recommendations may be generated using the system and methods disclosed herein that are tailored to the data. Implementations of the disclosed subject matter may be for multi-tenant systems, where there may be a plurality of customers and one or more data models for each of the plurality of customers. Recommendations may be generated for end users of the one or more customers.

Recommendations provided by current systems are based on a generic model that is not tailored to specific customer data. Rather, current systems use generative artificial intelligence (AI) with no customer-specific data knowledge or use a generic recommendation machine learning (ML) model that does not include any customer data. Implementations of the disclosed subject matter improve upon current systems by receiving customer data in a plurality of forms, training a data model based on the customer data and a recommendation objective, and providing recommendations based on the trained data model and the recommendation objective.

The combination of the user data and the recommendation objective increases the relevancy of the recommendations to the user. These recommendations may be dynamic and/or adaptive to new data to continuously offer relevant recommendations. That is, the training of the data model may differ based on the recommendation objective and the user interactions, and this training may improve recommendations and/or provide the user with more relevant information over current systems.

Systems and methods of the disclosed subject matter may use context entity data (e.g., user context, business context, entity context, and/or organization context, and the like) and metadata to generate recommendations based on a recommendation objective (e.g., that may be received from a customer). The recommendation objective may be used to train a DL and/or ML model to provide objective-based recommendations. Systems and methods of the disclosed subject matter may use profile data, which may be information that describes an individual, including attributes and engagement with a particular context. The engagement may include interactions such as viewing, selecting, and/or searching for items and/or information that is being recommended. Systems of the disclosed subject matter may use ambient data, which may be information regarding a user context, business context, or the like that may be determined from an interaction. The ambient data may be used in requesting a recommendation.

Example types and sub-types of data that may be used by implementations of the disclosed subject matter are detailed in Table 1 below.

TABLE 1
Example Data

| Type | Sub-Type | Definition | Examples |
|---|---|---|---|
| Ambient data | User Context | Information regarding | Identity, location, |
| | | the user that can be | referral source, |
| | | determined from an | channel, weather, |
| | | interaction | locale |
| | Business/Organization | Information | What product is |
| | Context | regarding a business | displayed on a web |
| | | or organization that | page, category of |
| | | may be determined | the web page |
| | | from an interaction | |
| | User Profile | Information that | Job title, company, |
| | | describes a unified | loyalty status |
| | | individual (using data | |
| | | for a user from one or | |
| | | more sources) including | |
| | | attributes and | |
| | | interactions | |
| Training and Model | Context Entity Data | What will be | Context Entity: |
| Data | and Metadata | recommended and | products, services, |
| | | the characteristics | content, and the like |
| | | and descriptions of | Metadata: Name, |
| | | the context entity, | Image, Inventory, |
| | | such as a business | URL, Price, Brands, |
| | | entity or | Style, Category |
| | | organization. This | |
| | | information may be | |
| | | used to understand | |
| | | the entity and its | |
| | | characteristics for | |
| | | training. These may | |
| | | be attributes that can | |
| | | be used to render a | |
| | | relevant recommendation | |
| | | (e.g., for a product, | |
| | | service, information, | |
| | | or the like). | |
| | User Business or | Information regarding | Entity clicks, time |
| | Organization Context | a user engagement | spent, views, |
| | Engagement (i.e., | with a business or | purchases, favoriting, |
| | context engagement | organization, such as | add to cart, or the |
| | data) | products viewed on a | like |
| | | website, products | |
| | | purchased on a | |
| | | website, information | |
| | | content subscribed to, | |
| | | webinars registered | |
| | | for, or the like. | |
| | User Profile Data | Information that | |
| | | describes a unified | |
| | | individual including | |
| | | attributes and | |
| | | interactions | |
| Reporting | Variation Engagement | Metrics and | Impressions, clicks |
| | Data | measurements to | (i.e., selection of |
| | | analysis campaign | content), opens (i.e., |
| | | effectiveness and | opening of email with |
| | | reach | targeted content) |
| | Objectives | Key metrics that may | Revenue, average order |
| | | be used to measure | value (AOV), Form Fills, |
| | | performance | Leads, and the like |

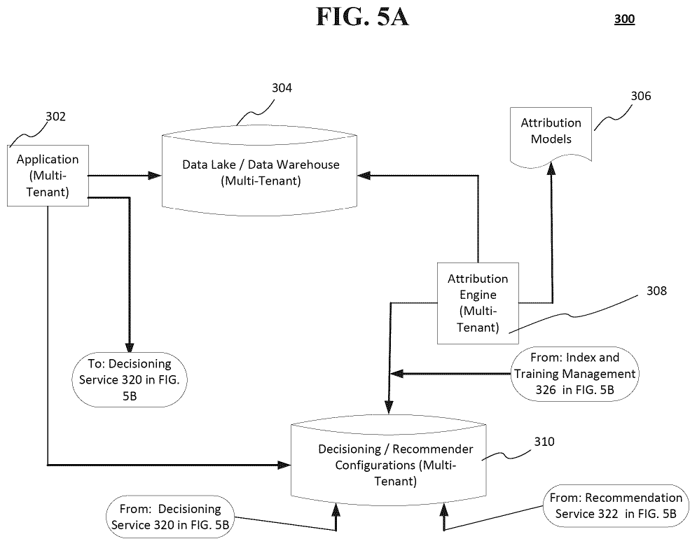

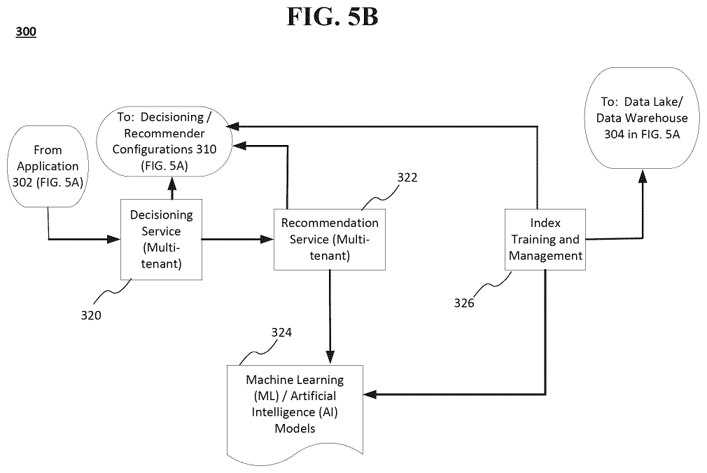

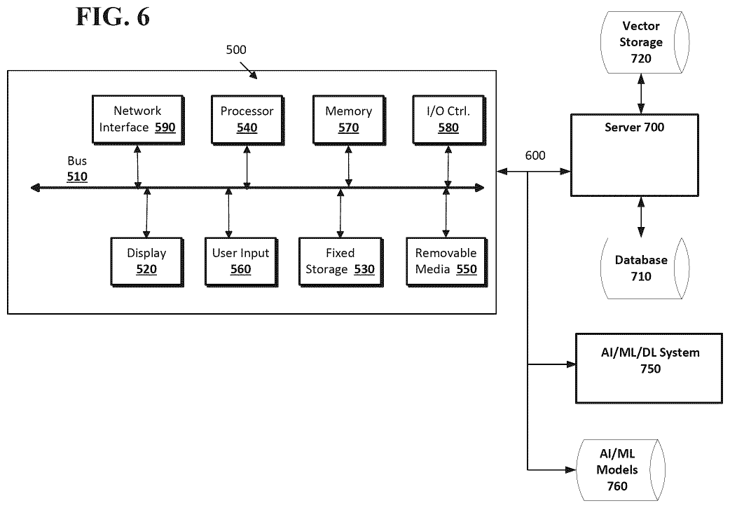

In the systems and methods of the disclosed subject matter for generating recommendations for a user, data model objects (DMOs) may be retrieved from a data lake and/or data warehouse (e.g., data warehouse 304 shown in FIG. 5B, which may be database 710 shown in FIG. 6) by the server (e.g., server 700 shown in FIG. 6) to generate a searchable index in a vector store (e.g., the searchable index of the vector store may be stored in vector storage 720 shown in FIG. 6). This searchable index may include information drawn from lake house data (e.g., attributes of the objects being recommended that may be stored in data lake of the data warehouse 304) and may be used to search vector data calculated by using ML and/or DL. The vector data may include, for example, ambient data such as user context data, business and/or organization context data, user profile data, and the like as shown in Table 1. This index may be used to provide predictions expressed as a function of one or more filters. The lake house data may be a data architecture that creates a single platform by combining data lakes (i.e., large repositories of raw data in its original form) and data warehouses that may be organized into sets of structured data.

Data that is retrieved from DMOs may be indexed into the vector search store (e.g., vector storage 720 show in FIG. 6) through an index management service within a customer data platform (CDP), which may be part of a server (e.g., server 700 shown in FIG. 6).

Systems and methods of the disclosed subject matter may be used to generate user embedding models and vector data, where the vector data may be included in the vector search store.

The user embeddings may be combined with data from the vector store and used to generate user-specific recommendations for a recommendation objective, which may include, but is not limited to: information and/or content recommendations; product recommendations; category recommendations; recommend support, articles, information or the like; recommend instructional classes based on previously taken classes; email personalization that may prompt a user to select a link and/or banner in an email; sales conversion; maximize click-through to increase revenue; provide objective-based recommendations, where the recommendation objectives may be customized; provide a decision tree and next steps, or the like.

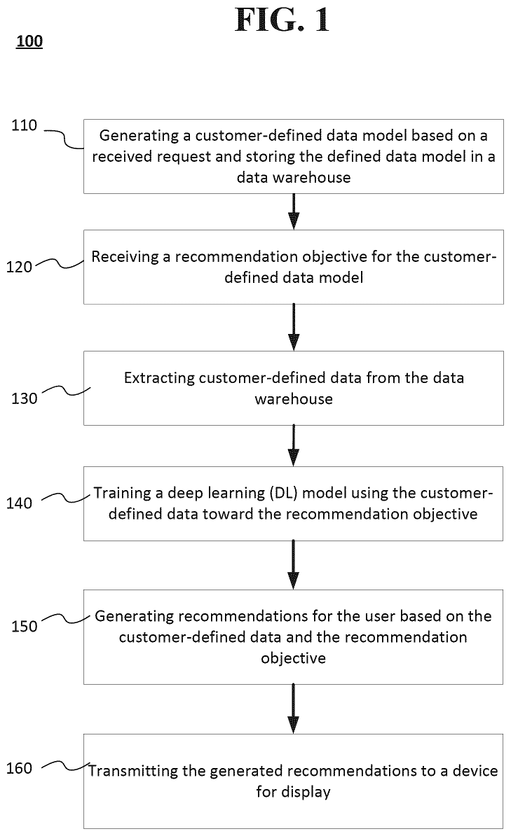

FIGS. 1-3 show an example method 100 of providing objective-based recommendations using a custom data model. Although FIGS. 1-3 show an example method for providing objective based recommendations for a single customer-defined data model and a single recommendation objective, this method may be used in a multi-tenant system having a plurality of customers, where each customer may have one or more data models and one or more corresponding recommendation objectives to provide recommendations to end users.

As shown in FIG. 1, a server (e.g., server 700 shown in FIG. 6 and described below) may generate a customer-defined data model based on a received request at operation 110. The data model may be a structure of data elements within an information system. The data model may include a plurality of different data elements for a customer, business, organization, and/or entity that may have their data stored as tenant data stored in a data model, and the data model may define and/or show the relationships between the plurality of data elements. Data models may define and structure data in the context of relevant processes for a customer, business, organization, entity, or the like. One or more data models may be generated based on different use cases and/or processes for the customer, business, organization, entity, or the like. That is, in operation 110, the customer (e.g., business, organization, entity, or the like) may define a new data model to be used for a new use case and/or process. The server may store the defined data model in a data warehouse (e.g., data warehouse of data warehouse 304 shown in FIG. 5A and/or database 710 shown in FIG. 6) that includes at least one storage device that is communicatively coupled to the server at operation 110.

At operation 120, the server may receive a recommendation objective for the customer-defined data model. The customer may define the recommendation objective based on the defined data model in the data warehouse. For example, the recommendation objective may be received by the server 700 shown in FIG. 6 from a customer's computer 500 via the communications network 600. The recommendation objective may be a key metric that may be used to measure performance, given the definition and structure of data for a process and/or use case in the customer-defined data model.

At operation 130, the server may extract customer-defined data from the data warehouse. For example, data used for training the ML model such as context entity data and metadata (as described above in Table 1) and/or user business or organization context engagement data (as described above in Table 1) may be extracted from the customer-defined data from the data warehouse.

At operation 140, the server may train a deep learning (DL) model using the customer-defined data toward the recommendation objective. The DL model may be part of AI/ML/DL System 750 shown in FIG. 6 and described below. The DL model may be trained using, for example, the training and model data such as context entity data and metadata, and/or the user business or organization context engagement data. The trained DL model may be used to generate recommendations for a user that are toward a customer-defined recommendation objective that may be one or more key metrics to measure performance based for a process and/or use case in the customer-defined data model.

At operation 150, the server may generate one or more recommendations for the user based on the customer-defined data and the recommendation objective for the user. The generation of the one or more recommendations may be further described below in connection with FIGS. 5A-5B, where the decisioning service 320 and the recommendation service 322 of FIG. 5B may be used to generate recommendations for the user.

At operation 160, the server may transmit the generated one or more recommendations to a device of the user for display. For example, the server may transmit the recommendations to computer 500 shown in FIG. 6 that is communicatively coupled to the server 700 via communications network 600. In some implementations, the method 100 may include receiving a request at the server for personalized content based on an identifier for the user. The request may be transmitted, for example, by a website, application, and/or email that the user is viewing and/or interacting with. The generating the one or more recommendations at operation 150 and the transmission of the generated one or more recommendations at operation 160 may be based on the received request for the personalized content.

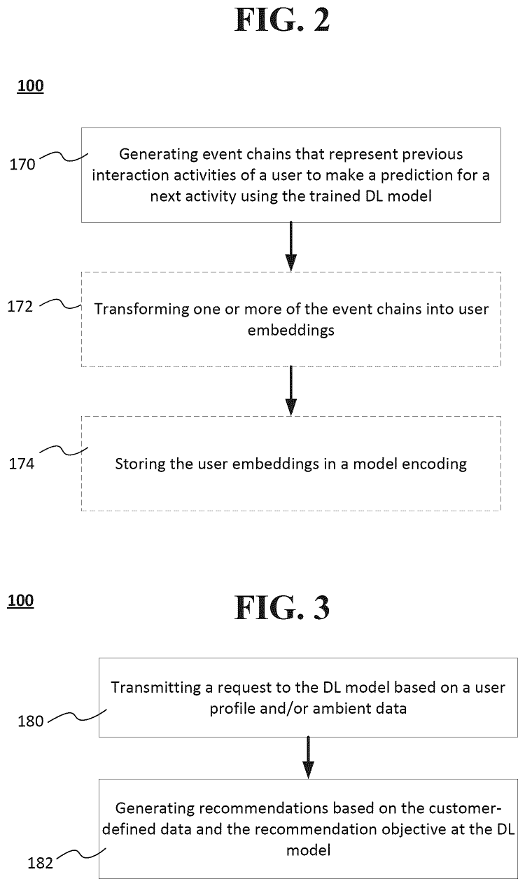

FIG. 2 shows example additional operations of method 100 according to implementations of the disclosed subject matter. At operation 170, the server may generate event chains that represent previous interaction activities of a user to make a prediction for a next activity using the trained DL model. In some implementations, the event chains may include one or more user interactions with one or more data items in the data warehouse. The event chains may be p-chains, which may be multi-step variations of Markov chains that represent previous activities that may be used to make a prediction for a next activity. That is, traditional Markov chains may be used to look back one step for user interactions, whereas the p-chains of the implementations of the disclosed subject matter may consider a plurality of steps of user interactions. At operation 172, the server may transform one or more of the event chains into user embeddings. At operation 174, the user embeddings may be stored in a ML and/or AI model encoding. The model encoding may be, for example, a PyTorch™ model which includes a ML and/or AI library which may be used as the model encoding for the embeddings. The AI/ML/DL system 750 and/or the AL/ML models 760 shown in FIG. 6 may be used to generate the embeddings to be stored in an ML and/or AI encoding.

FIG. 3 shows example additional operations of method 100 according to implementations of the disclosed subject matter. At operation 180, the server may transmit a request to the DL model based on a user profile, ambient data, or the like. The DL model may be part of AI/ML/DL system 750 shown in FIG. 6. The DL model may generate recommendations based on the customer-defined data and the recommendation objective for the user. The generated recommendations may be transmitted to the server.

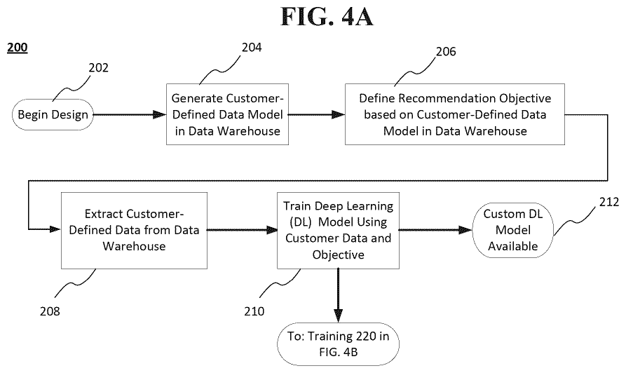

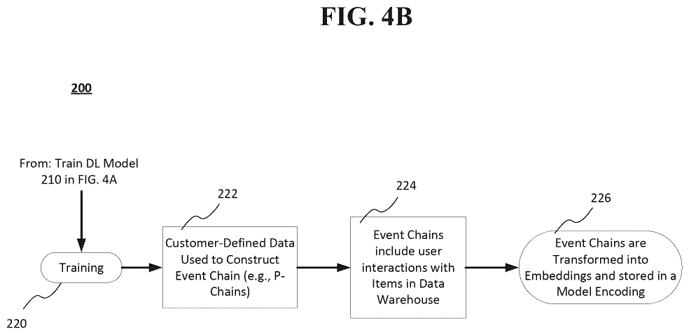

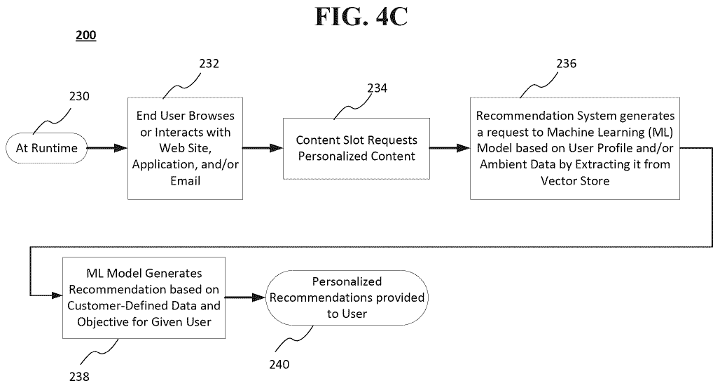

FIGS. 4A-4C show an example method 200 to generate recommendations based on an objective according to implementations of the disclosed subject matter. The operations of method 200 of FIGS. 4A-4C may be similar to at least some of the operations of example method 100 described above and shown in FIGS. 1-3. Method 200 and FIGS. 4A-4C may show operations of generating a recommendation based on an objective in three different stages: (1) a design stage, as shown in FIG. 4A; (2) a training stage, as shown in FIG. 4B; and (3) a runtime stage, as shown in FIG. 4C.

As shown in FIG. 4A, operations 202, 204, 206, 208, 210, and 212 may be directed to defining a recommendation objective and generating a customer deep learning (DL) model that abides to the customer-defined recommendation objective. These operations may be part of a first stage of operations that is the design stage. As shown in FIG. 4B, operations 220, 222, 224, and 226 may be directed to training the DL model, which may be a second stage of operations that is the training stage. Operations 230, 232, 234, 236, 238, and 240 shown in FIG. 4C relate to runtime operations, where a user may interact with a website, application, email, or the like, and a recommendation generates a personalized recommendation for the user based on the recommendation objective and the trained DL model, which may be a third stage of operations.

As shown in FIG. 4A, operation 202 may begin design-related operations to define a recommendation objective and generate the custom DL model that is configured to make recommendations for a user. At operation 204, a server (e.g., server 700 shown in FIG. 6) may generate a customer-defined data model in a data warehouse (e.g., data warehouse that is part of data warehouse 304 in FIG. 5A and/or database 710). This may be similar to operation 110 shown in FIG. 1 and described above. At operation 206, the server may receive a recommendation objective defined by a customer based on the customer-defined data model in the data warehouse. This may be similar to operation 120 of FIG. 1 described above. At operation 208, the server may extract customer-defined data from the data warehouse, which may be similar to operation 130 shown in FIG. 1 and described above. At operation 210 the DL model may be trained toward the defined recommendation objective using the customer data to form the customer DL model as operation 212. This may be similar to operation 140 of FIG. 1 described above.

The training of the DL model at operation 210 of FIG. 4A may be performed starting at operation 220 of FIG. 4B, which may be part of the training stage. At operation 222, customer-defined data may be used to generate an event chain, which may be a p-chain as discussed above in connection with operation 170 shown in FIG. 2. At operation 224, event chains may be generated that include interactions by users with items that are stored in the data warehouse. At operation 226, the event chains may be transformed into embeddings, and stored in a model encoding (e.g., PyTorch™ model, as described above in connection with operations 172 and 174 of FIG. 2).

FIG. 4C shows runtime operations that are part of a runtime stage. The runtime operations may begin at operation 230, where the user interactions may generate a request to provide personalized recommendations to the user based on the recommendation objective and the trained DL model. The objective may be received and/or defined at operation 120 shown in FIG. 1 and described above, and/or operation 206 shown in FIG. 4A and described above. The DL model may be trained at operation 140 shown in FIG. 1 and described above, and/or operation 210 shown in FIG. 4A, as well as operations 220, 222, 224, and 226 shown in FIG. 4B and described above.

At operation 232, a user may browse and/or interact with a website, an application, an email, or the like using a device (e.g., computer 500 shown in FIG. 6). At operation 234, one or more content slots of a website to be viewed and/or browsed, an application being used, and/or an email may request personalized content (e.g., a personalized content block or personalized content piece) for the user viewing the website, application, and/or email from the recommendation system (e.g., which may be part of recommendation service 322 shown in FIG. 5B and/or server 700 shown in FIG. 6).

The browsing and/or interacting by the user with the website, application, and/or email may generate events that are stored in the data warehouse (e.g., data warehouse 304 shown in FIG. 5A and/or database 710 shown in FIG. 6). These generated events may represent p-chains, as described above. These generated events may be used to personalize future interactions by the user with the website, application, and/or emails. For example, the future interactions may include the user's next interaction with the website during the same session, or during a future session with the website. The generated event data may be used to train the DL model at operation 220 of FIG. 4B, as discussed above, using the p-chains.

The request for personalized content for the user at operation 234 may be based on a user identifier (e.g., user ID that is assigned by the system for a particular user), a cookie (e.g., a website cookie that may be used by the website to remember information about prior visits by the user, which may make it easier to visit the site again and make the site more useful to and/or personalized for the user), or the like. The request for personalized content may be similar to operation 180 shown in FIG. 3 and described above.

At operation 236, the recommendation system may generate a request to an ML model (e.g., ML/AI model 324 shown in FIG. 5B, and/or AI/ML model 760 shown in FIG. 6). In some implementations, the ML model may be DL model that is trained at operation 210 for FIG. 4A. At operation 238, the ML model may generate recommendations based on the customer-defined data and the recommendation objective for the user. At operation 240, the personalized recommendation may be transmitted to the user device (e.g., computer 500 shown in FIG. 6) to be displayed.

FIGS. 5A-5B show an example system 300 configured to perform objective-based recommendations of method 100 of FIGS. 1-3 and/or method 200 shown in FIGS. 4A-4C according to implementations of the disclosed subject matter. The example system 300 may be a multi-tenant system that is configured to be used by different customers (e.g., tenants) to provide recommendations to one or more end users of the respective different customers. Application 302, which may be a multi-tenant application, may be used to define data objects (e.g., user data objects, business data objects, and the like). In some implementations, the data objects may be the data model objects (DMOs) described above. The data objects may be used to generate customer-defined applications. Application 302 may be executed by server 700 shown in FIG. 6. Application 302 may transmit data from the data objects to a data warehouse 304. The data warehouse 304 may be a data lake and/or a data warehouse, which may be part of database 710 shown in FIG. 6. The data warehouse 304 may store data objects (e.g., business data objects, user data objects, and the like) for processing and/or data warehousing.

The application 302 may allow a customer and/or administrator to define decisioning rules and/or recommender attributes, which may be transmitted to the decisioning/recommender configurations 310. The decisioning/recommender configurations 310 may store customer-defined decision-making rules and recommender decisions based on a unique customer defined data model. The decisioning/recommender configuration 310 may be part of server 700 and/or database 710 shown in FIG. 6.

Attribution engine 308, which may be a multi-tenant attribution engine, may be configured to process context engagement data and perform attribution of indicators (e.g., Key Performance Indicator (KPI) for business and/or users, and the like) to decision-making. The attribution engine 308 may be part of server 700 shown in FIG. 6. The context engagement data may be the “User Business or Organization Context Engagement” data sub-type of the data type of “Training and Model Data” shown above in Table 1. The attribution engine 308 may extract customer data from the data warehouse of data warehouse 304 to perform attribution (e.g., determine which user engaged with a particular website, product, information, application, email, or the like, and the details of the interaction). The attribution engine 308 may use attribution models 306 to determine context engagement data for one or more attribution models that are stored in attribution models 306, which may be part of database 710 shown in FIG. 6. The context engagement data may be data that is generated when a user engages with a portion of a website, an application, an email, or the like, and the context engagement data may be stored in the data warehouse 304. The attribution engine 308 may provide accurate attribution of objectives to be achieved by one or more recommendations provided to a user. For example, a recommendation to a user for a product may trigger a purchase by the user which may be a qualifying event for the defined recommendation objective.

The attribution engine 308 may transmit extracted customer-defined attribution and engagement signal configurations to the decisioning/recommender configurations 310, which may use the extractions and the engagement signal configurations to increase the quality of recommendations provided to the user based on the objective. That is, the extracted customer-defined attribution and the engagement signal configurations may be used as part of a feedback loop to improve the recommendations made to a user.

The decisioning service 320 shown in FIG. 5B may be a multi-tenant service that may be configured to generate applications that may provide personalized recommendations based on contextual data (e.g., user profiles) and/or based on a recommendation objective. The decisioning service may be part of server 700 shown in FIG. 6. The decisioning service 320 may provide contextual data for an ongoing user session (e.g., with a web page session, application session, and/or interaction with an email). The decisioning service 320 may provide rule-based recommendations that are not tied to the objective. The decisioning service 320 may receive one or more requests for decisions and/or recommendations from the application 302 shown in FIG. 5A. The decisioning service 320 may transmit requests for recommendations to recommendation service 322.

Recommendation service 322 shown in FIG. 5B, which may be a multi-tenant service, may extract customer-defined recommender definitions from the decisioning/recommender configurations 310. The recommendation service 322 may be part of server 700 shown in FIG. 6. The recommendation service 322 may transmit requests for personalized recommendations based on a customer-defined data model, customer-defined recommender and end-user context to the machine learning (ML)/artificial intelligence (AI) models 324.

The ML/AI models 324 may be stored in AI/ML models 760 shown in FIG. 6. The ML/AI models 324 may be trained based on customer-defined recommender definition, customer-define data model, and data from the data warehouse 304.

The index and training management 326 may be multi-tenant, and may generate training configurations based on the customer-defined recommender definitions, the recommendation objectives, and/or the customer-defined data model. The index and training management 326 may train the ML/AI models 324 using data from the data warehouse of the data warehouse 304. The index and training management 324 may extract customer-defined recommender definitions from the decisioning/recommender configurations 310, and may extract customer data from the data warehouse of the data warehouse 304 based on customer-defined data model and the customer-defined recommender model.

Implementations of the disclosed subject matter may be implemented in and used with a variety of component and network architectures. As discussed in further detail herein, the computer 500 may be a single computer in a network of multiple computers. The computer 500 may be a device used by a user to receive objective-based personalized recommendations in connection with the example methods discussed above in connection with FIGS. 1-5B.

In some implementations, the computer 500 may communicate with and may be used to receive one or more responses generated by server 700, AI/ML/DL system 750 (that may include artificial intelligence (AI), machine learning (ML), and/or Deep Learning (DL) systems), AI/ML/DL models 760, via communications network 600. The server 700, AI/ML/DL system 750, and/or AI/ML models 760 may be one or more hardware servers, virtual machines, cloud servers, databases, clusters, application servers, neural network systems, processors, devices, computers, or the like. Although one server 700, database 710, vector storage 720, AI/ML/DL system 750, and/or AI/ML models760 may be a plurality of servers and or databases communicatively coupled to communications network 600 which may operate in concert with one another. The server 700 may be communicatively coupled to database 710 and vector storage 720, and/or may include database 710 and/or vector storage 720. In some implementations, the vector storage 720 may be part of the database 710. The database 710, the vector storage 720, and/or the AI/ML models 760 may use any suitable combination of any suitable volatile and non-volatile physical storage mediums, including, for example, hard disk drives, solid state drives, optical media, flash memory, tape drives, registers, and random access memory, or the like, or any combination thereof. The database 710 may store data, such as tenant data (e.g., in a multi-tenant database system), which may include user interaction data with applications, web pages, emails, and the like, and may include ambient data, training and model data, reporting data, and the like as described above in connection with Table 1. The vector storage 720 may store a searchable index and the like as described above. The generative AI/ML/DL system 750 and/or the AI/ML models 760 may be trained to generate personalized recommendations for a user based on a recommendation objective and customer-defined data as described above.

The computer (e.g., user computer, enterprise computer, or the like) 500 may include a bus 510 which interconnects major components of the computer 500, such as a central processor 540, a memory 570 (typically RAM, but which can also include ROM, flash RAM, or the like), an input/output controller 580, a user display 520, such as a display or touch screen via a display adapter, a user input interface 560, which may include one or more controllers and associated user input or devices such as a keyboard, mouse, Wi-Fi/cellular radios, touchscreen, microphone/speakers and the like, and may be communicatively coupled to the I/O controller 580, fixed storage 530, such as a hard drive, flash storage, Fibre Channel network, SAN device, SCSI device, and the like, and a removable media component 550 operative to control and receive an optical disk, flash drive, and the like.

The bus 510 may enable data communication between the central processor 540 and the memory 570, which may include read-only memory (ROM) or flash memory (neither shown), and random-access memory (RAM) (not shown), as previously noted. The RAM may include the main memory into which the operating system, development software, testing programs, and application programs are loaded. The ROM or flash memory can contain, among other code, the Basic Input-Output system (BIOS) which controls basic hardware operation such as the interaction with peripheral components. Applications resident with the computer 500 may be stored on and accessed via a computer readable medium, such as a hard disk drive (e.g., fixed storage 530), an optical drive, floppy disk, or other storage medium 550.

The fixed storage 530 can be integral with the computer 500 or can be separate and accessed through other interfaces. The fixed storage 530 may be part of a storage area network (SAN). A network interface 590 can provide a direct connection to a remote server via a telephone link, to the Internet via an internet service provider (ISP), or a direct connection to a remote server via a direct network link to the Internet via a POP (point of presence) or other technique. The network interface 590 can provide such connection using wireless techniques, including digital cellular telephone connection, Cellular Digital Packet Data (CDPD) connection, digital satellite data connection or the like. For example, the network interface 590 may enable the computer to communicate with other computers and/or storage devices via one or more local, wide-area, or other networks. The service resource 404 and/or one or more user devices 750 may have components that are similar to the computer 500 described above.

Many other devices or components (not shown) may be connected in a similar manner (e.g., data cache systems, application servers, communication network switches, firewall devices, authentication and/or authorization servers, computer and/or network security systems, and the like). Conversely, all the components shown in FIG. 6 need not be present to practice the present disclosure. The components can be interconnected in different ways from that shown. Code to implement the present disclosure can be stored in computer-readable storage media such as one or more of the memory 570, fixed storage 530, removable media 550, or on a remote storage location.

Some portions of the detailed description are presented in terms of diagrams or algorithms and symbolic representations of operations on data bits within a computer memory. These diagrams and algorithmic descriptions and representations are commonly used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all these and similar terms are to be associated with the appropriate physical quantities and are merely convenient labels applied to these quantities. Unless specifically stated otherwise as apparent from the above discussion, it is appreciated that throughout the description, discussions utilizing terms such as “generating”, “extracting”, “training”, “transmitting”, “transforming”, “storing”, “receiving”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

More generally, various implementations of the presently disclosed subject matter can include or be implemented in the form of computer-implemented processes and apparatuses for practicing those processes. Implementations also can be implemented in the form of a computer program product having computer program code containing instructions implemented in non-transitory and/or tangible media, such as hard drives, solid state drives, USB (universal serial bus) drives, CD-ROMs, or any other machine readable storage medium, wherein, when the computer program code is loaded into and executed by a computer, the computer becomes an apparatus for practicing implementations of the disclosed subject matter. Implementations also can be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium can be implemented by a general-purpose processor, which can transform the general-purpose processor or a device containing the general-purpose processor into a special-purpose device configured to implement or carry out the instructions. Implementations can be implemented using hardware that can include a processor, such as a general-purpose microprocessor and/or an Application Specific Integrated Circuit (ASIC) that implements all or part of the techniques according to implementations of the disclosed subject matter in hardware and/or firmware. The processor can be coupled to memory, such as RAM, ROM, flash memory, a hard disk or any other device capable of storing electronic information. The memory can store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described to explain the principles of implementations of the disclosed subject matter and their practical applications, to thereby enable others skilled in the art to utilize those implementations as well as various implementations with various modifications as can be suited to the particular use contemplated.

1. A method comprising:
generating, at a server, a customer-defined data model based on a received request and storing the defined data model in a data warehouse that includes at least one storage device that is communicatively coupled to the server;
receiving, at the server, a recommendation objective for the customer-defined data model;
extracting, at the server, customer-defined data from the data warehouse;
training, at the server, a deep learning (DL) model using the customer-defined data toward the recommendation objective;
generating, at the server, one or more recommendations for the user based on the customer-defined data and the recommendation objective for the user; and
transmitting, at the server, the generated one or more recommendations to a device of the user for display.

2. The method of claim 1, further comprising:
generating, at the server, event chains that represent previous interaction activities of a user to make a prediction for a next activity using the trained DL model.

3. The method of claim 2, wherein the event chains include one or more user interactions with one or more data items in the data warehouse.

4. The method of claim 2, further comprising:
transforming, at the server, one or more of the event chains into user embeddings; and
storing the user embeddings in a model encoding.

5. The method of claim 1, further comprising:
receiving, at the server, a request for personalized content based on an identifier for the user,
wherein the generating the one or more recommendations and the transmission of the generated one or more recommendations is based on the received request for the personalized content.

6. The method of claim 1, further comprising:
transmitting, at the server, a request to the DL model based on at least one selected from the group consisting of: a user profile, and ambient data; and
generating, at the DL model, recommendations based on the customer-defined data and the recommendation objective for the user; and
transmitting the generated recommendations to the device of the user for display.

7. The method of claim 1, further comprising:
extracting, at an attribution engine of the server, customer data from the data warehouse;
extracting, at the attribution engine of the server, a customer-defined attribution and engagement signal configuration;
analyzing, at the attribution engine of the server, the extracted customer data for context engagement data based on the extracted customer-defined attribution and engagement signal configuration;
performing, at the attribution engine of the server, attribution of at least one performance indicator to one or more of the context engagement data based on at least one attribution model; and
storing the attribution at the data warehouse.

8. The method of claim 1, wherein the generating the customer-defined data model, the receiving the recommendation objective, the extracting the customer-defined data, the training the deep learning model, and the generating the one or more recommendations, and the transmitting the one or more recommendations is performed by the server for one or more different customers in a multi-tenant system of the server.

9. A system comprising:
a data warehouse comprising at least one storage device; and
a server communicatively coupled to the data warehouse, the configured to:
generate a customer-defined data model based on a received request and store the defined data model in the data warehouse;
receive a recommendation objective for the customer-defined data model;
extract, at the server, customer-defined data from the data warehouse;
train a deep learning (DL) model using the customer-defined data toward the recommendation objective;
generate one or more recommendations for the user based on the customer-defined data and the recommendation objective for the user; and
transmit the generated one or more recommendations to a device of the user for display.

10. The system of claim 9, wherein the server is configured to generate event chains that represent previous interaction activities of a user to make a prediction for a next activity using the trained DL model.

11. The system of claim 10, wherein the event chains include one or more user interactions with one or more data items in the data warehouse.

12. The system of claim 10, wherein the server is configured to transform one or more of the event chains into user embeddings, and storing the user embeddings in a model encoding.

13. The system of claim 9, wherein the server is configured to receive a request for personalized content based on an identifier for the user, wherein the generating the one or more recommendations and the transmission of the generated one or more recommendations is based on the received request for the personalized content.

14. The system of claim 9, wherein the server is further configured to:
transmit a request to the DL model based on at least one selected from the group consisting of: a user profile, and ambient data;
generate, at the DL model, recommendations based on the customer-defined data and the recommendation objective for the user; and
transmit the generated recommendations received from the DL model to the device of the user for display.

15. The system of claim 9, wherein the server comprises an attribution engine that is configured to:
extract customer data from the data warehouse;
extract a customer-defined attribution and engagement signal configuration;
analyze the extracted customer data for context engagement data based on the extracted customer-defined attribution and engagement signal configuration;
perform attribution of at least one performance indicator to one or more of the context engagement data based on at least one attribution model; and
store the attribution at the data warehouse.

16. The system of claim 9, wherein the server is at least part of a multi-tenant system that is configured to generate the customer-defined data model, receive the recommendation objective, extract the customer-defined data, train the deep learning model, and generate the one or more recommendations, and transmit the one or more recommendations for one or more different customers in the multi-tenant system.
